(19) United States
(12) Patent Application Publication
(10) Pub. No.: US 2025/0276743 A1
(43) Pub. Date: Sep. 4, 2025

(54) ACCESSORY SYSTEM FOR A VEHICLE HAVING A PICKUP BED

(71) Applicant: RANGER DESIGN INC., Baie d'Urfe (CA)

(72) Inventors: Jay COWIE, Baie d'Urfe (CA); John-Philip VENTURI, Baie d'Urfe (CA); Randal COWIE, Baie d'Urfe (CA); Bruno D'AMICO, Baie d'Urfe (CA); Francois GRAVEL, Baie d'Urfe (CA)

(21) Appl. No.: 19/066,795

(22) Filed: Feb. 28, 2025

Related U.S. Application Data
(60) Provisional application No. 63/560,388, filed on Mar. 1, 2024.

(51) Int. Cl. B62D 33/02; B60R 3/00; B60R 11/06; B62D 33/08

(52) U.S. Cl. CPC B62D 33/0207; B60R 3/007; B60R 11/06; B62D 33/08

(57) ABSTRACT

An accessory system for a vehicle having a pickup bed, including a frame configured for selectively connecting to a rear portion of the vehicle, the frame being connected to and extending over the pickup bed when the frame is installed on the vehicle. The frame is arranged and configured to selectively receive a plurality of cooperating accessories, each accessory of the plurality of cooperating accessories being configured to connect to the frame individually and simultaneously with other accessories of the plurality of cooperating accessories. A toolbox for an accessory system including a toolbox body defining a cavity and shaped and arranged to be received in an accessory system frame; and a toolbox door including: a latch defined in a bottom side of the toolbox door, and a handle for selectively opening the latch, the handle being disposed on the bottom side of the toolbox door.

### CROSS-REFERENCE

The present application claims priority to U.S. Provisional Patent Application No. 63/560,388, entitled “Accessory System for a Vehicle having a Pickup Bed,” filed Mar. 1, 2024, the entirety of which is incorporated by reference herein.

### TECHNICAL FIELD

The present technology relates to accessory systems for vehicles having a pickup bed.

### BACKGROUND

Vehicles with pickup beds, generally referred to as pickup trucks, are commonly used for labor, either professional or recreational. To supplement or customize transport capabilities, these vehicles sometimes have retrofits to transport tools, supplies, etc. In some cases, the retrofit could include additional structures or accessories installed in or over the pickup bed.

Different types of work, or even different tasks in the same line of work, may require different vehicle retrofits. For instance, toolboxes to carry tools may be required for one task, while a canopy to protect objects in the pickup bed may required for another. These different needs may be conflicting, requiring the removal of one structure to permit the installation of another. In some cases, some structures such as canopies are not easily removed and may leave holes or damage where the structure was attached to the vehicle body.

In some cases, multiple retrofit structures or accessories may be installed together by modification thereof. For example, ladder racks may be added to a canopy by drilling holes in the canopy to fasten the ladder racks thereto. After-market addition of the ladder racks is thus not convenient, especially for an unplanned need. Further, selective removal of the ladder racks would leave holes to be repaired in such an instance.

Therefore, there is a desire for a solution addressing at least some of these drawbacks.

### SUMMARY

It is an object of the present technology to ameliorate at least some of the inconveniences present in the prior art.

In accordance with an aspect of the present technology, there is provided an accessory system to be connected to the vehicle and extending over the pickup bed. The system includes a frame that can be selectively connected to or removed from the pickup bed, permitting the user install or remove the system as required. The frame is connected to the vehicle using clamps by the present technology, permitting a drill-less installation of the system on the vehicle. The rigid members of the frame are further configured to fasten together, such that the frame construction (either on the vehicle directly or before connecting to the vehicle) also does not require drilling, welding, and/or modification of the frame or frame members.

By the present technology, the accessory system is further configured to permit the installation of one or many of the cooperating accessories simultaneously. The cooperating accessories include, but are not limited to, toolboxes, one or more top rack members, a cab rack extension, a cargo rack, a canopy, a rear door, one or more ladder racks, one or more mounting hooks, and a cab barrier. For instance and as is illustrated herein, the frame is configured and arranged to simultaneously receive thereon: two toolboxes, a cargo rack formed from three top rack members, a cab rack extension, a canopy, a rear door, and two ladder racks. The frame is also configured to be installed on the vehicle with fewer or none of these accessories. In some cases, one or more side doors could be included in place of a toolbox or toolboxes. Each of the accessories is installed using fasteners and slots defined in the frame, thereby providing drill-less installation of the accessories in the frame as well.

By the present technology, toolboxes for selectively connecting to the frame and for selective use on a vehicle with a pickup bed are also disclosed. The toolbox has a toolbox body defining a cavity configured and shaped to receive objects therein and a toolbox door pivotally connected to the toolbox body. The toolbox door selectively closes the cavity and opens to an exterior of the frame, such that the contents of the toolbox can be accessed from an exterior of the vehicle. The latch and handle of the toolbox door are disposed on a bottom edge thereof, leaving a maximum expanse of the exterior side of the toolbox door generally uniform. This permits application of markings, logos, advertisements, and the like. The toolbox body closes a lateral side opening of the frame, and extends into a space interior to the frame.

In accordance with an aspect of the present technology, there is provided an accessory system for a vehicle having a pickup bed, the system including a frame configured for selectively connecting to a rear portion of the vehicle, the frame being connected to and extending over the pickup bed when the frame is installed on the vehicle, the frame being arranged and configured to selectively receive a plurality of cooperating accessories, each accessory of the plurality of cooperating accessories being configured to connect to the frame individually and simultaneously with other accessories of the plurality of cooperating accessories.

In some embodiments, the accessory system further includes at least one accessory of the plurality of cooperating accessories.

In some embodiments, the plurality of cooperating accessories comprises at least one of: at least one toolbox; at least one top rack member; a cargo rack formed from a plurality of rack rigid members; a cab rack extension; a canopy; a rear door; a ladder rack; at least one mounting hook; at least one side door; and a cab barrier.

In some embodiments, the at least one toolbox further includes a toolbox body defining a cavity configured and shaped to receive objects therein, and a toolbox door pivotally connected to the toolbox body, the toolbox door selectively closing the cavity; and when the at least one toolbox is selectively connected to the frame: the toolbox body closes a lateral side opening of the frame, and the toolbox door opens to an exterior of the frame.

In some embodiments, the accessory system further includes a plurality of clamps for selectively connecting the frame to side walls of the pickup bed.

In some embodiments, the frame includes a first base frame member configured to selectively connect to a first side wall of the pickup bed; a second base frame member configured to selectively connect to a second side wall of the pickup bed; two first rising frame members connected to the first base frame member, a lower end portion of each first rising frame member being connected to the first base frame member; two second rising frame members connected to the second base frame member, a lower end portion of each second rising frame member being connected to the first base frame member; a first top frame member connected to upper end portions of the two first rising frame members; a second top frame member connected to upper end portions of the two second rising frame members; and a third top frame member extending between and connected to the first top frame member and the second top frame member.

In some embodiments, the first top frame member extends parallel to the first base frame member; and the second top frame member extends parallel to the second base frame member.

In some embodiments, each of the first rising frame members extends upward and inward from the first base frame member to the first top frame member; and each of the second rising frame members extends upward and inward from the second base frame member to the second top frame member.

In some embodiments, the third top frame member includes a rigid member; and at least one extension member moveably connected to the rigid member, the at least one extension member being selectively slidable relative to the rigid member permitting an adjustment of a width of the frame.

In some embodiments, each of the first rising frame members and each of the second rising frame members has two slots defined therein, the two slots extending from the lower end portion to the upper end portion.

In some embodiments, the two slots of each of the first rising frame members and each of the second rising frame members is shaped to selectively secure at least one fastener therein, each slot having an opening narrower than a largest width of the slot.

In some embodiments, each of the first top frame member and the second top frame member includes a top frame member body having four sides extending from a rear of the frame to a front portion of the frame, the top frame member body having at least one slot defined in each of the four sides.

In some embodiments, each of the four slots of the first top frame member and the second rising frame member is shaped to selectively secure at least one fastener therein, each slot having an opening narrower than a maximum width of the slot.

In some embodiments, the first base frame member, the second base frame member, the two first rising frame members, the two second rising frame members, the first top frame member, the second top frame member, and the third top frame member are formed from extruded aluminum.

In some embodiments, each of the first base frame member and the second base frame member further comprises a plurality of clamps for selectively connecting the frame to side walls of the pickup bed.

In some embodiments, the first top frame member and the second top frame member each define a longitudinal slot therein; and the longitudinal slot is shaped to receive a portion of a canopy for selectively connecting the canopy to the frame.

In accordance with another aspect of the present technology, there is provided an accessory system frame for a vehicle having a pickup bed, the frame including a first base frame member configured to selectively connect to a first side wall of the pickup bed; a second base frame member configured to selectively connect to a second side wall of the pickup bed; two first rising frame members connected to the first base frame member, a lower end portion of each first rising member being connected to the first base frame member; two second rising frame members connected to the second base frame member, a lower end portion of each second rising member being connected to the first base frame member; a first top frame member connected to upper end portions of the two first rising frame members; a second top frame member connected to upper end portions of the two second rising frame members; and a third top frame member extending between and connected to the first top frame member and the second top frame member, the frame being configured to selectively connect to a rear portion of the vehicle, the frame being connected to and extending over the pickup bed when the frame is installed on the vehicle, the frame being arranged and configured to selectively receive a plurality of cooperating accessories, each accessory of the plurality of cooperating accessories being configured to connect to the frame individually and simultaneously with other accessories of the plurality of cooperating accessories.

In some embodiments, the first top frame member extends parallel to the first base frame member; and the second top frame member extends parallel to the second base frame member.

In some embodiments, each of the first rising frame members extends upward and inward from the first base frame member to the first top frame member; and each of the second rising frame members extends upward and inward from the second base frame member to the second top frame member.

In some embodiments, the third top frame member includes a rigid member; and at least one extension member moveably connected to the rigid member, the at least one extension member being selectively slidable relative to the rigid member permitting an adjustment of a width of the frame.

In some embodiments, each of the first rising frame members and each of the second rising frame members has two slots defined therein, the two slots extending from the lower end portion to the upper end portion.

In some embodiments, the two slots of each of the first rising frame members and each of the second rising frame members is shaped to selectively secure at least one fastener therein, each slot having an opening narrower than a largest width of the slot.

In some embodiments, each of the first top frame member and the second top frame member includes a top frame member body having four sides extending from a rear of the frame to a front portion of the frame, the top frame member body having at least one slot defined in each of the four sides.

In some embodiments, each of the four slots of the first top frame member and the second rising frame member is shaped to selectively secure at least one fastener therein, each slot having an opening narrower than a maximum width of the slot.

In some embodiments, the first base frame member, the second base frame member, the two first rising frame members, the two second rising frame members, the first top frame member, the second top frame member, and the third top frame member are formed from extruded aluminum.

In some embodiments, each of the first base frame member and the second base frame member further comprises a plurality of clamps for selectively connecting the frame to side walls of the pickup bed.

In some embodiments, the frame further includes a fourth top frame member extending between and connected to the first top frame member and the second top frame member, the fourth top frame member being disposed rearward of the third top frame member.

In some embodiments, the frame further includes a plurality of clamps for selectively connecting the first base frame member and the second base frame member to side walls of the pickup bed.

In accordance with yet another aspect of the present technology, there is provided a toolbox for an accessory system, the toolbox including a toolbox body defining a cavity configured and shaped to receive objects therein, the toolbox body being shaped and arranged to be received in an accessory system frame; and a toolbox door pivotally connected to the toolbox body, the toolbox door selectively closing the cavity, the toolbox door including: a latch defined in a bottom side of the toolbox door, and a handle for selectively opening the latch, the handle being disposed on the bottom side of the toolbox door.

In some embodiments, the toolbox door further comprises a sealing gasket disposed on an interior side of the toolbox door.

In some embodiments, the toolbox body forms a gutter arrangement.

In some embodiments, the toolbox further includes a composite end cap for selectively fastening objects to the toolbox body.

For purposes of this application, terms related to spatial orientation when referring to the accessory system or components thereof such as forwardly, rearwardly, top, bottom, left, and right are as they would normally be understood by a driver of the vehicle sitting thereon in a normal riding position with the accessory system installed thereon.

Embodiments of the present technology each have at least one of the above-mentioned aspects, but do not necessarily have all of them. Additional and/or alternative features, aspects, and advantages of embodiments of the present technology will become apparent from the following description, the accompanying drawings, and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a top, rear, right side perspective view of a vehicle with an accessory system according to non-limiting embodiments of the present technology mounted thereon;

FIG. 2 is a top, rear, right side perspective view of the accessory system of FIG. 1;

FIG. 3 is another top, rear, right side perspective view of the accessory system of FIG. 1;

FIG. 4 is a top plan view of the accessory system of FIG. 1;

FIG. 5 is a cross-sectional view of the accessory system of FIG. 1, taken along line 5-5 of FIG. 4;

FIG. 6 is a close-up, cross-sectional view of portions of a frame of the accessory system of FIG. 1, taken from portion 6 of FIG. 5;

FIG. 7 is a cross-sectional view of the frame of the accessory system of FIG. 1, taken along line 7-7 of FIG. 5;

FIG. 8 is a top, front, left side perspective view of the accessory system of FIG. 1, with additional accessories of the system connected thereto;

FIG. 9 is a rear elevation view of the accessory system of FIG. 8;

FIG. 10 is a left side elevation view of the accessory system of FIG. 8;

FIG. 11 is a front, left side perspective view of the accessory system of FIG. 8;

FIG. 12 is a rear, right side perspective view of the accessory system of FIG. 8;

FIG. 13 is a top, rear, right side perspective view of the vehicle with the accessory system mounted thereon, with an alternative set of accessories connected thereto;

FIG. 14 is a top, front, left side perspective view of the accessory system of FIG. 1, with another alternative set accessories of the system connected thereto;

FIG. 15 is a rear, left side perspective view of the accessory system and accessories of FIG. 14;

FIG. 16 is a rear, side perspective view of a toolbox of the accessory system of FIG. 1; and

FIG. 17 is a bottom, side perspective view of the toolbox of FIG. 16.

It should be noted that the Figures may not be drawn to scale, unless otherwise noted.

### DETAILED DESCRIPTION

In accordance with the present technology, an accessory system 100 for a vehicle 10 having a pickup bed is described. Such vehicles, generally those referred to as pickup trucks, have a cab for the driver and one or more passengers and a pickup bed. The pickup bed, as generally described herein, is defined by a rear side of the cab, two side walls, and a rear side door (generally referred to as a tailgate).

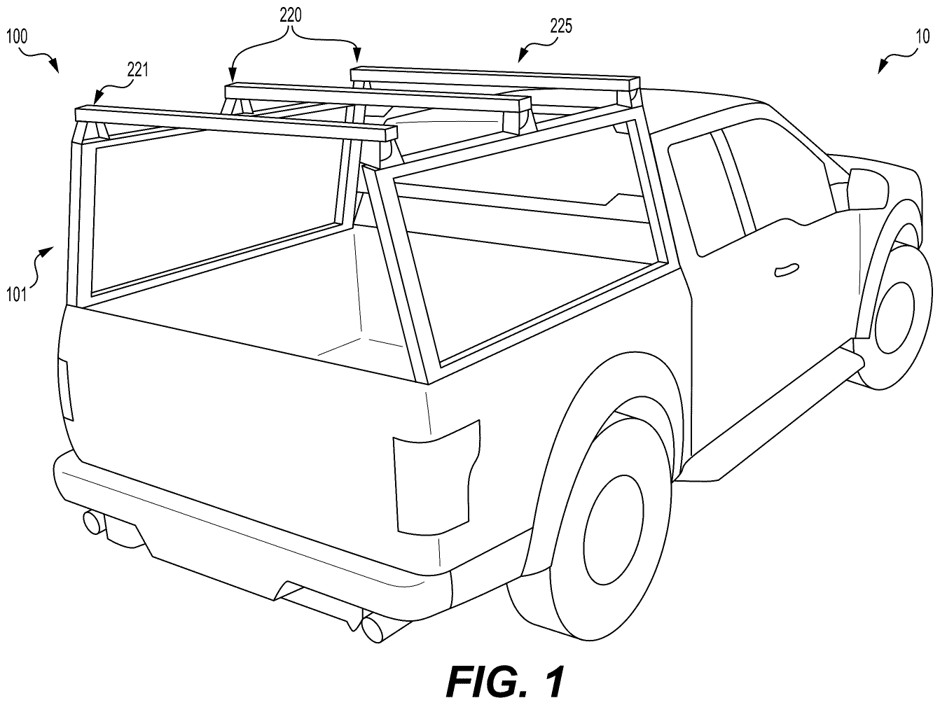

With reference to FIG. 1, the accessory system 100, also referred to herein as the system 100, is provided to selectively connect one or more cooperating accessories to the vehicle 10. To receive the one or more accessories, the system 100 includes a frame 101 for selectively connecting to the vehicle 10, specifically to a rear portion of the vehicle 10. When the system 100 is connected to and installed on the vehicle 10, the frame 101 extends over the pickup bed of the vehicle 10. As will be described in more detail below, the frame 101 is selectively connected to the pickup bed side walls.

The frame 101 is arranged and configured to selectively receive a plurality of cooperating accessories. Specifics of the different accessories will be described in more detail below. By the present technology, each accessory is shaped and configured to connect to the frame 101 individually and simultaneously with other cooperating accessories of the system 100. By the present technology, the system 100 includes a series of clamps 99 for selectively connecting the frame 101 to side walls of the pickup bed. It is contemplated that the frame 101 could be selectively connected to the vehicle 10 in different manners.

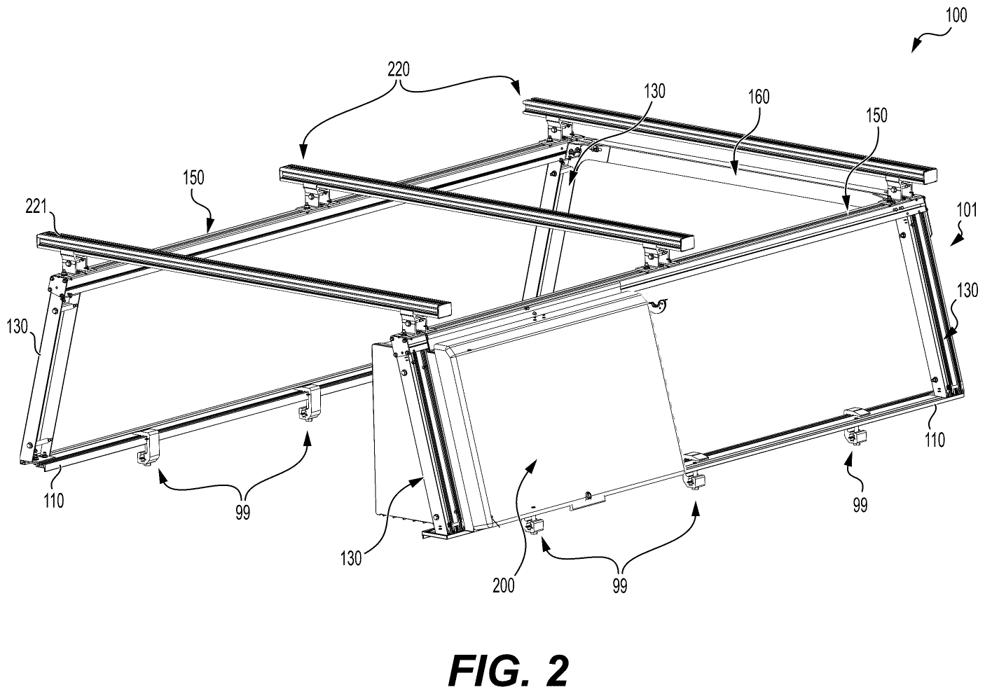

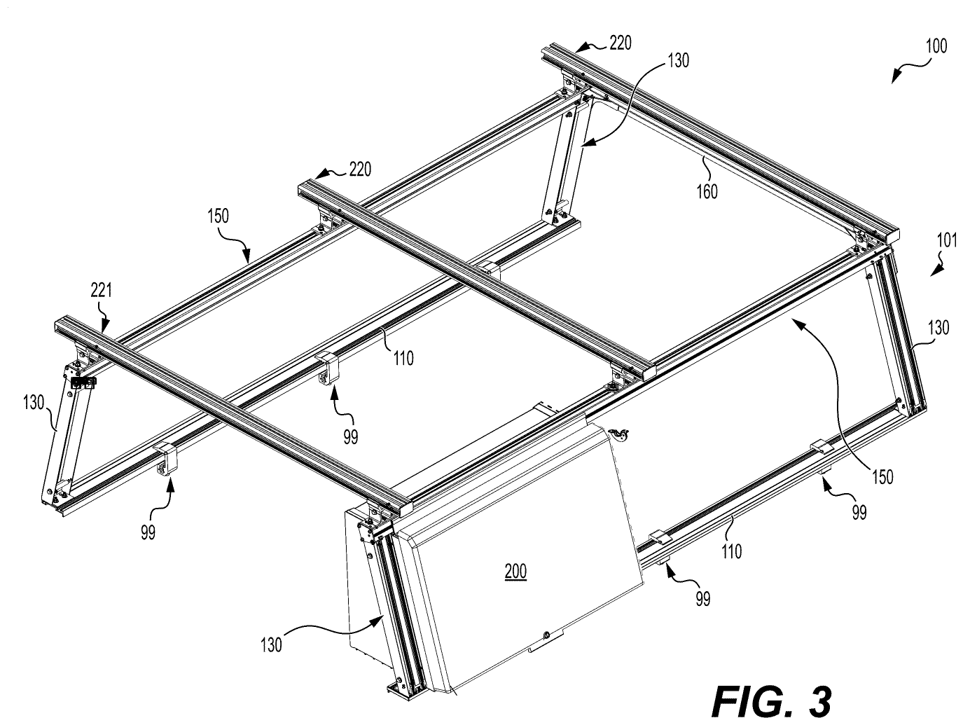

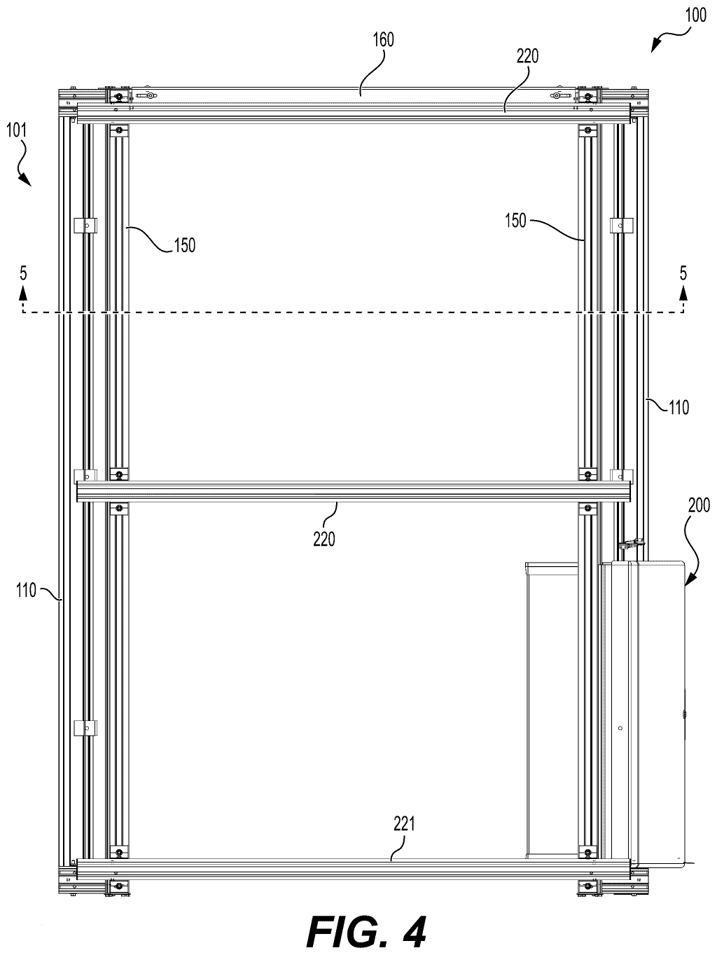

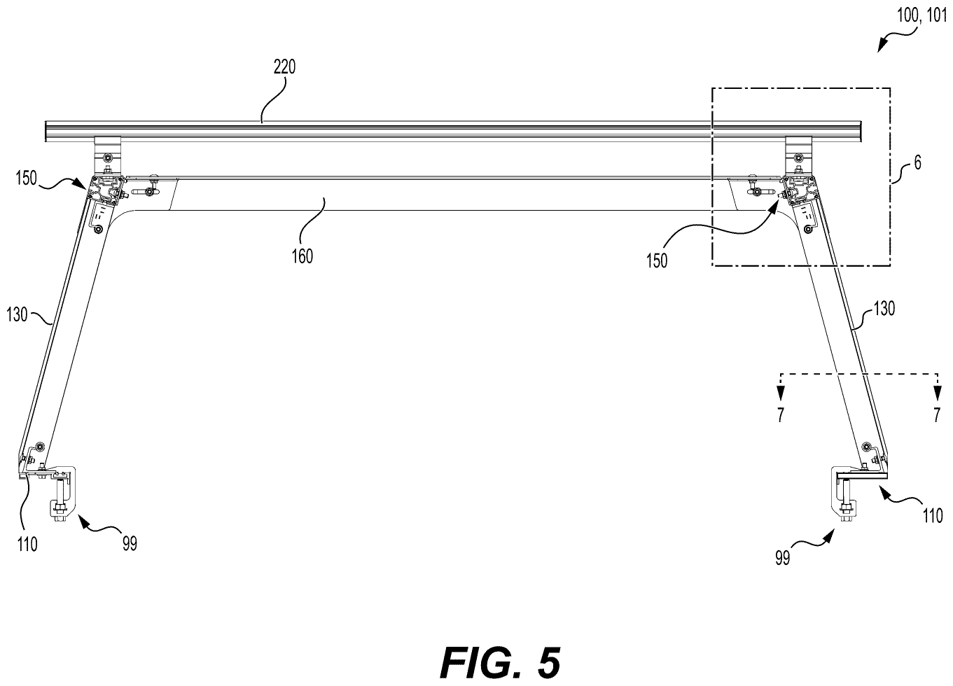

With additional reference to FIGS. 2 to 5, the frame 101 includes a left base frame member 110 configured to selectively connect to a left side wall of the pickup bed and a right base frame member 110 configured to selectively connect to a right side wall of the pickup bed. Each base member 110 is shaped to rest on an upper surface and along the longitudinal length of the corresponding side wall. Weight of the frame 101, as well the weight of accessories and objects supported thereby, are thus transferred to the vehicle 10 via the base frame members 110. The clamps 99 anchor the base frame members 110 to the corresponding side wall. In the illustrated embodiment, the clamps 99 are applied to the base frame members 110 when installing the frame 101 to the vehicle 10. In some embodiments, one or more clamps 99 could be integrally formed with or affixed to the base frame members 110.

The frame 101 further includes two rising frame members 130 connected to each base frame member 110. A lower end portion of each rising member 130 is connected to the corresponding base frame member 110. Specifically, the lower end portion of each rising member 130 is fastened to the corresponding base frame member 110.

In the illustrated embodiment, one rising frame member 130 is positioned at a front end and a rear end of each base frame member 110. There is thus one rising frame member 130 at each corner of the frame 101. It is contemplated that the exact positioning of the rising frame members 130 could vary in some embodiments.

The frame 101 further includes a left top frame member 150 connected to upper end portions of the two left rising frame members 130 and a right top frame member 150 connected to upper end portions of the two right rising frame members 130. A front (third) top frame member 160 extends between and is connected to the left and right top frame members 150. A left end portion of the front top frame member 160 is fastened to a forward portion of the left top frame member 150 and a right end portion of the front top frame member 152 is fastened to a forward portion of the right top frame member 150.

The left top frame member 150 extends parallel to the left base frame member 110 and the right top frame member 150 extends parallel to the right base frame member 110. In the illustrated embodiment, the top members 150 and the base members 110 are further all arranged parallel to one another. Each of the rising frame members 130 extends upward and inward from its corresponding base frame member 110 to its corresponding top frame member 150. As such, the frame 101 forms a trapezoidal volume, similar in shape to standard pickup truck canopies. The exact shape and volume formed by the frame 101 could vary in different embodiments.

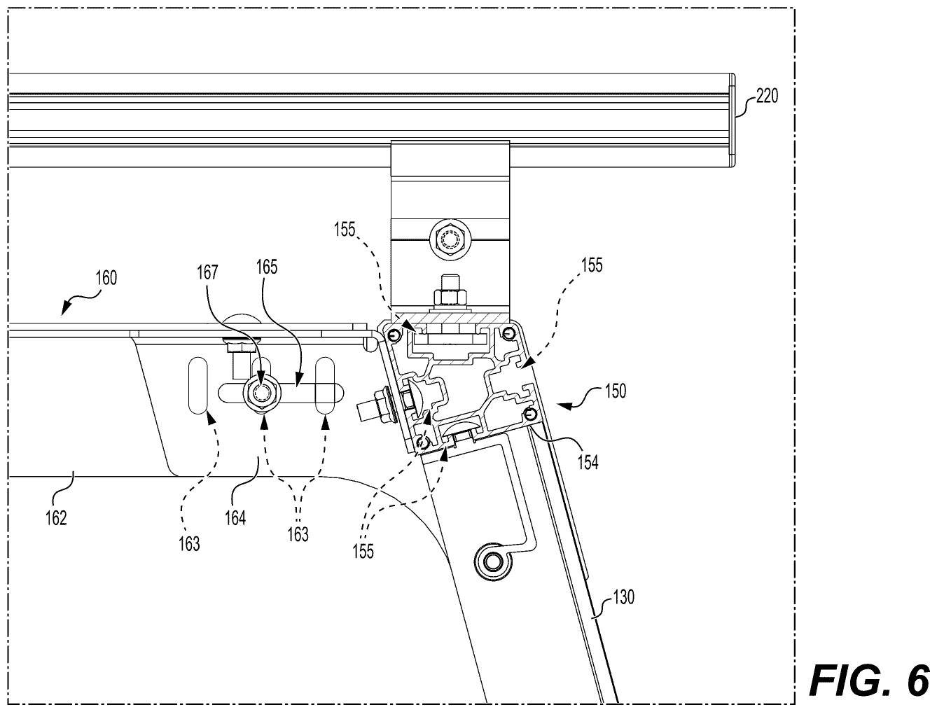

With additional reference to FIG. 6, the front top frame member 160 is formed from a rigid member 162 and one or more extension members 164 moveably connected to the rigid member 162. In the illustrated embodiment the frame member 160 includes two extension members 164. It is contemplated that the frame member 160 could have more or fewer extension members 164, depending on the embodiment. Each extension member 164 is selectively slidable relative to the rigid member 162, specifically along a slot 165 in the present embodiment. The sliding extension member 164 permits the frame member 160 to change in length, thereby adjusting of a width of the frame 101. A fastener 167, a bolt 167 as illustrated, extends through the slot 165 and through an aperture 163 defined in the rigid member 162 to selectively fix the relative position of the extension member 164 relative to the rigid member 162. In the present embodiment, the rigid member 162 has three apertures 163 defined in each end portion, but the exact number could vary. The total length of the front top frame member 160, and thus the width of the frame 101, is thus selectively adjustable by loosening one or both fasteners 167 and moving one or both of the extension members 164 relative to the rigid member 162. The adjustable width permits the user to adjust the width of the frame 101 to the exact width of the pickup bed, as vehicles of a same make and model may have small variability in their exact pickup bed width. For example, some vehicles 10 may have a liner or coatings applied to the walls of the pickup bed, which would slightly decrease the separation between the pickup bed side walls. The adjustable width of the frame 101 may also permit a greater ease of installation and securing the frame 101 in place on the vehicle 10. In some embodiments, the extension member 164 could have a plurality of laterally-spaced holes defined therein in place of the slot 165. The plurality of laterally-spaced holes would be arranged to permit the fastener 167 to selectively adjust the length of the front top frame member 160 as described above. The embodiment of the extension member 164 having the plurality of laterally-spaced holes could be used with the rigid member 162 with the apertures 163 described above. It is also contemplated that the embodiment of the extension member 164 having the plurality of laterally-spaced holes could be used with a rigid member having a slot defined therein.

In the illustrated embodiment, the frame 101 further includes a rear (fourth) top frame member 221. The member 221 extends between and is connected to the left and right top frame members 150. Specifically, the top frame member 221 is disposed rearward of the front top frame member 160. Depending on the aspect ratio of the frame members 110, 130, 150, 160, it is contemplated that the rear frame member could be omitted in some embodiments.

In some implementations, the frame 101 could include a rear (fourth) top frame member extending between and connected to the left and right top frame members 150, similar to the front (third) top frame member 160. Such a rear top frame member could be implemented alternatively or additionally to the top frame member 221. A left end portion of such a rear top frame member would be fastened to a rear portion of the left top frame member 150 and a right end portion of the rear top frame member would be fastened to a rear portion of the right top frame member 150.

In the illustrated embodiment, the rear frame member 221 is formed by a rigid member 221 that simultaneously serves as a rack member for a roof rack 225 for the system 100. The rigid member 221 is fastened to a top side of the left and right top members 150, and extends thereabove. It is contemplated that the frame 101 could include a rear frame member aligned and parallel to the front top frame member 160 in some embodiments.

With continued reference to FIG. 6, each of the left and right top frame members 150 has a top frame member body 152 having four sides extending from a rear of the frame 101 to a front portion of the frame 101. Each top frame member body 152 has a slot 155 defined in each of the four sides. Each slot 155 is shaped to selectively secure one or more fasteners therein, each slot 155 having an opening narrower than a maximum width of the slot 155. In this way, the head of a fastener (such as a bolt) can slide into the slot 155 at a front or rear portion of the member 150, and then an item can subsequently be fastened to the fastener, in turn selectively securing the item to the frame 101. As is illustrated, the front top member 160 and the rising member 130 are fastened to the top member 150 via the slots 155. In the present embodiment, the rack members 220 are also fastened to the member 150 via the slots 155.

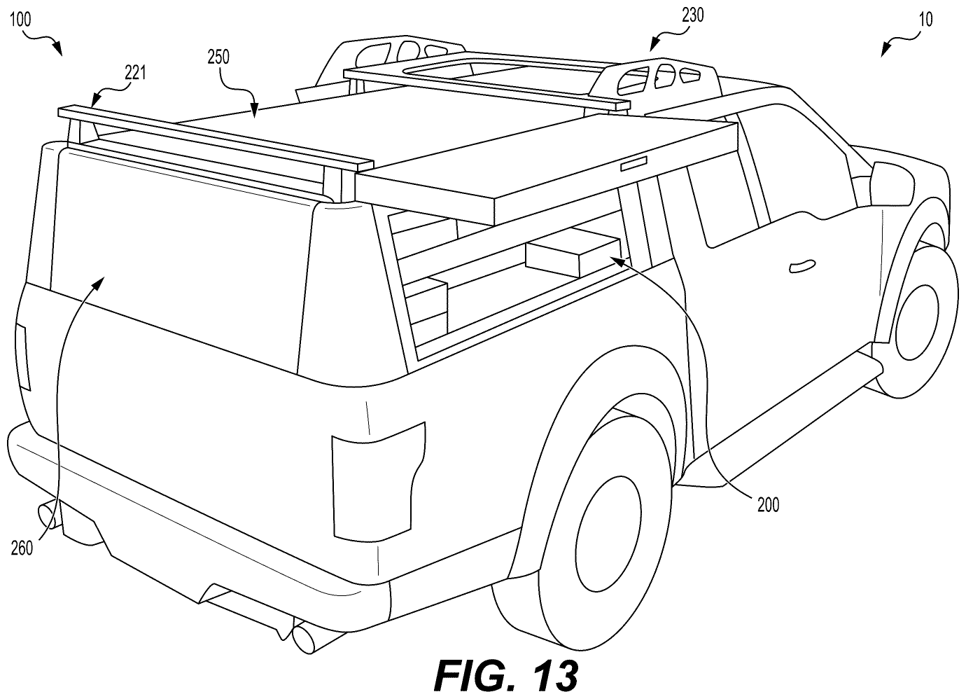

In some embodiments, each of the left and right top frame members 150 could further have a longitudinal slot formed in the top frame member body 152. The longitudinal slot is shaped to receive a portion of a canopy 250 for selectively connecting the canopy 250 to the frame 101; see for instance FIGS. 13 to 15. By providing a selective attachment of the canopy 250 to the frame 101, the system 100 may be easily converted from being open on a top side to closed. For instance, the canopy 250 could be removed to carry large items or equipment and replaced for inclement weather.

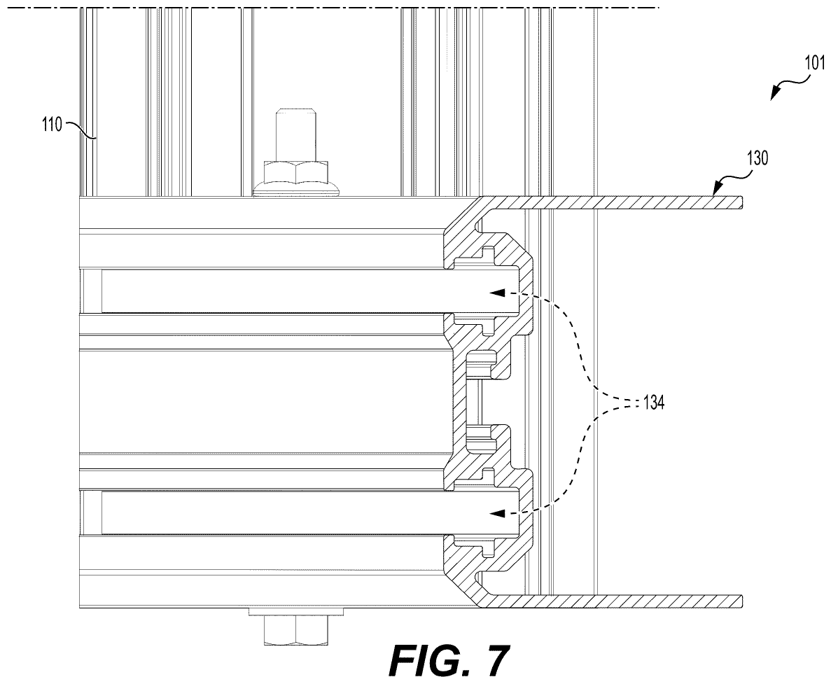

With additional reference to FIG. 7, each of the rising frame members 130 has two slots 134 defined therein. The two slots 134 extend from the lower end portion of each rising frame member 130 to the upper end portion thereof. The slots 134 are defined in an exterior facing side of the frame members 130. It is contemplated that additional sides of the members 130 could have similar slots defined therein. It is also contemplated that one or more rising frame members 130 could have more or fewer than two slots defined therein.

Similarly to the slots 155, each slot 134 is shaped to selectively secure fasteners therein. Each slot 134 has an opening narrower than a largest width of the slot 134. In this way, the head of a fastener (such as a bolt) can slide into the slot 134 at a top portion of the member 130, and then an item can then be fastened to the fastener, in turn selectively securing the item to the frame 101.

The base frame members 110, the rising frame members 130, and the top frame members 150 are formed from extruded aluminum. It is contemplated that different surface treatments and processing could be applied thereto, specifics of which depend on the embodiment. By forming the members 110, 130, 150 by extrusion, including directly forming the slots 134 and the slots 155, the frame 101 can be sized to a variety of different vehicles 10 without requiring complicated design changes. The members 110, 130, 140 are simply sized to the pickup bed upon formation. It is contemplated that different materials and fabrication methods could be implemented in different embodiments.

As is mentioned briefly above, the members 110, 130, 140 are all fastened together. As such, welding is not required: neither prior to shipping to an end user (thereby facilitating shipping) nor by the final user upon installation on the vehicle 10 (thereby simplifying installation).

As is noted above, the system 100 is configured and arranged to provide selective connection of multiple different accessories to the vehicle 10, over the pickup bed. By the present technology, the frame 101 is shaped and arranged to receive multiple of the following accessories simultaneously: one or more toolboxes 200; one or more top rack members 220; a cab rack extension 230; a canopy 250; a rear canopy door 260; one or more ladder racks 270; one or more side doors 280; one or more mounting hooks (not shown); and a cab barrier (not shown). The cab rack extension 230 connects to the frame 101 and extends forward over the cab of the vehicle 10. The cab barrier is a separator disposed between the frame 101 and the cab of the vehicle 10. In at least some cases, the cab barrier can aid in protecting the cab from movement of items inside the pickup bed. In some embodiments, the system 100 includes a cargo rack 225 formed from two or more rack rigid members 220, 221. See, for instance, FIG. 1. It is also contemplated that an integrally formed cargo rack could be provided in some cases.

In some embodiments the system 100 could be provided with only the frame 101 for installation on the vehicle 10, with accessories to be procured separately. In some embodiments, the system 100 could be provided with the frame 101 and one or more of the above described accessories.

It further noted that system 100 is configured to receive any and all of the above noted accessories simultaneously, except where the two accessories are meant to occupy the same space. For example, the toolboxes 200 and the side doors 280 are both configured to occupy lateral sides of the frame 101.

Different arrangements of cooperating accessories are illustrated in the embodiments of the Figures. In FIG. 1, the system 100 is illustrated with the cargo rack 225 installed on the frame 101. In FIGS. 2 to 4, the system 100 is illustrated with the cargo rack 225 and one toolbox 200 (partially cut-away for illustrative purposes) installed on the frame 101.

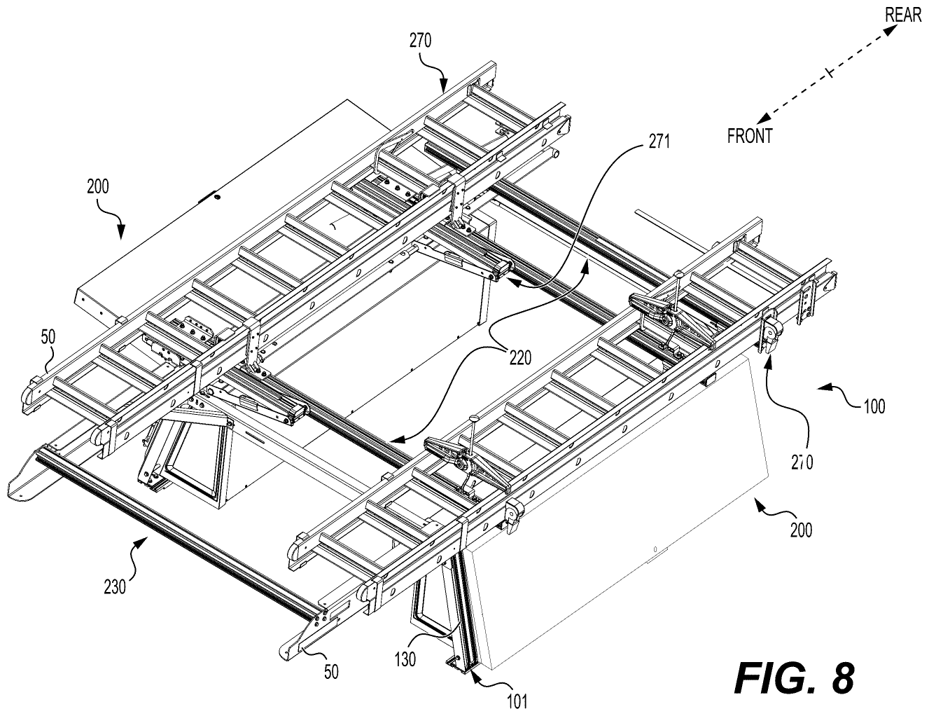

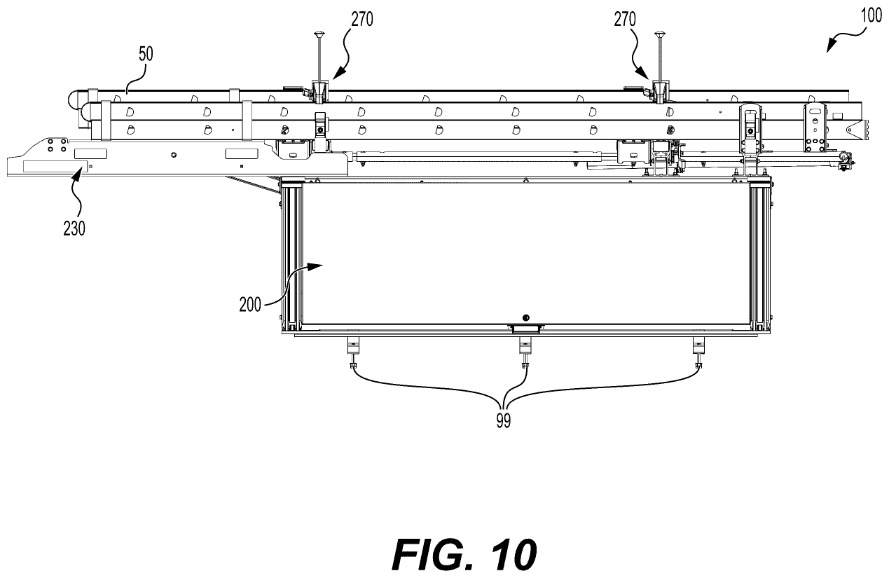

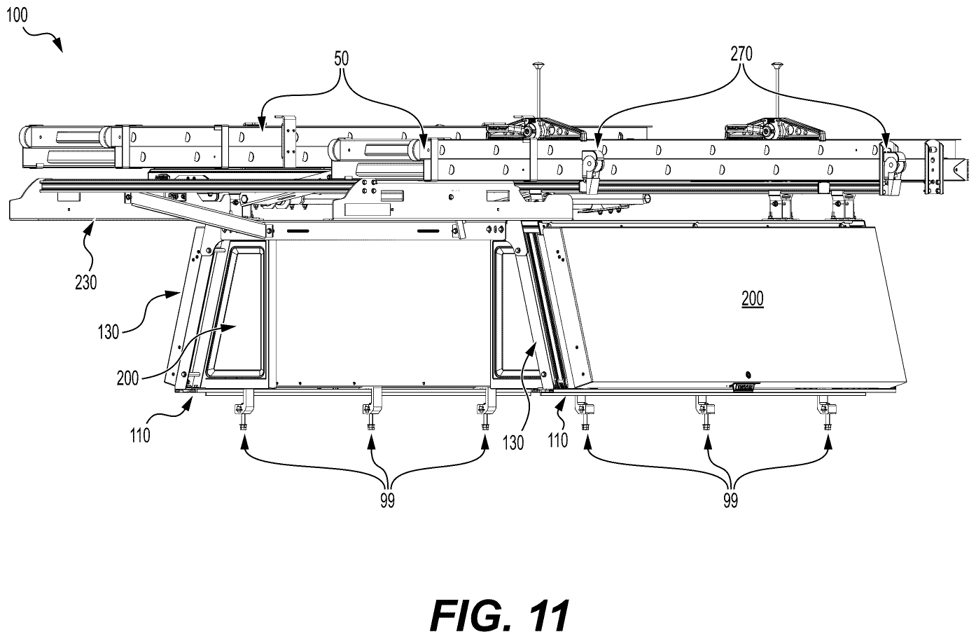

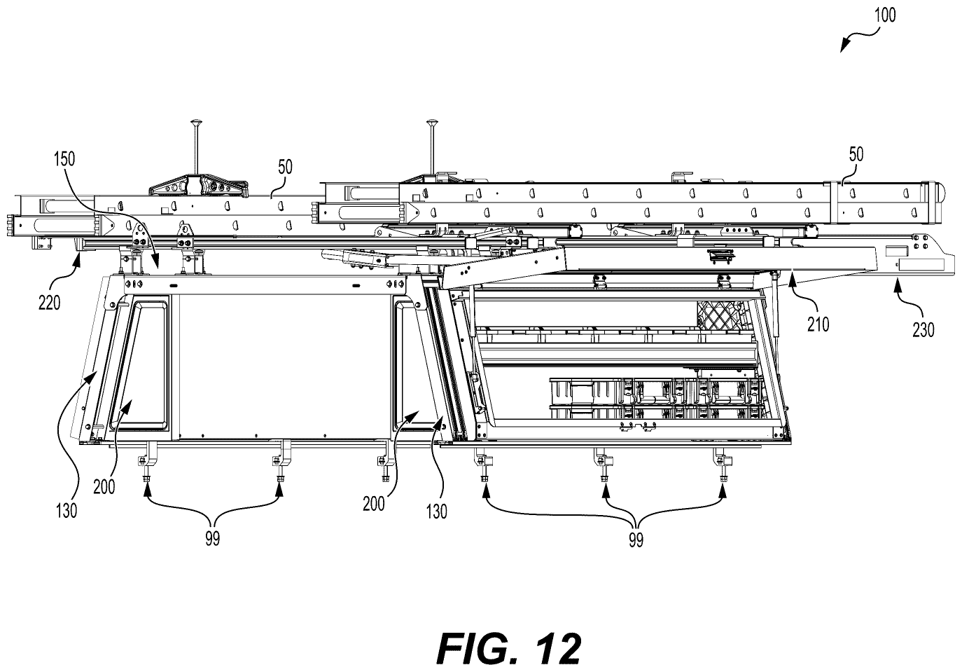

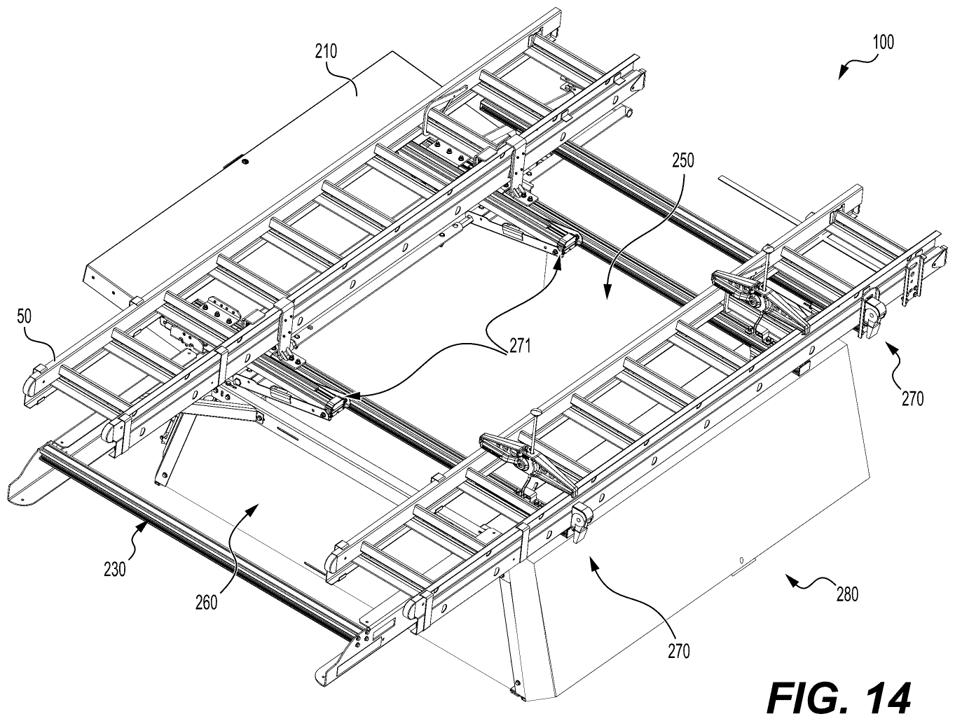

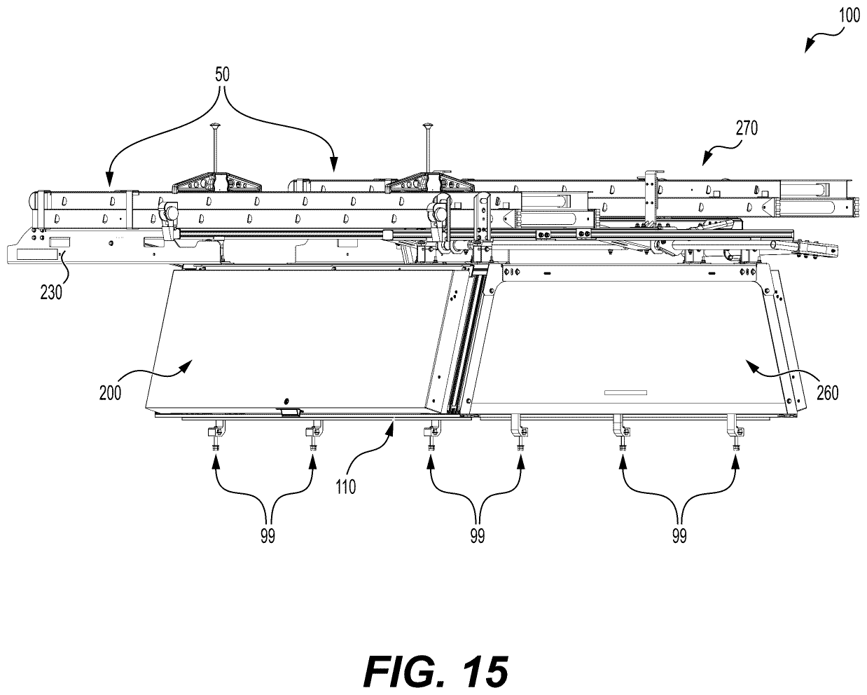

In FIGS. 8 to 12, the system 100 is illustrated with the cargo rack 225, two sets of ladder racks 270 (including one with a lifting system 271) shown holding ladders 50, two toolboxes 200, and the cab rack extension 230 installed simultaneously on the frame 101. In FIG. 13, the system 100 is illustrated with one rack member 221, two toolboxes 200, the cab rack extension 230, the canopy 250, and the rear canopy door 260 installed simultaneously on the frame 101. In FIGS. 14 and 15, the system 100 is illustrated with one rack member 221, one toolbox 200, the cab rack extension 230, the canopy 250, the rear canopy door 260, and one side door 280 installed simultaneously on the frame 101. The side door 280 permits access to an interior of the pickup bed through a lateral side of the system 100.

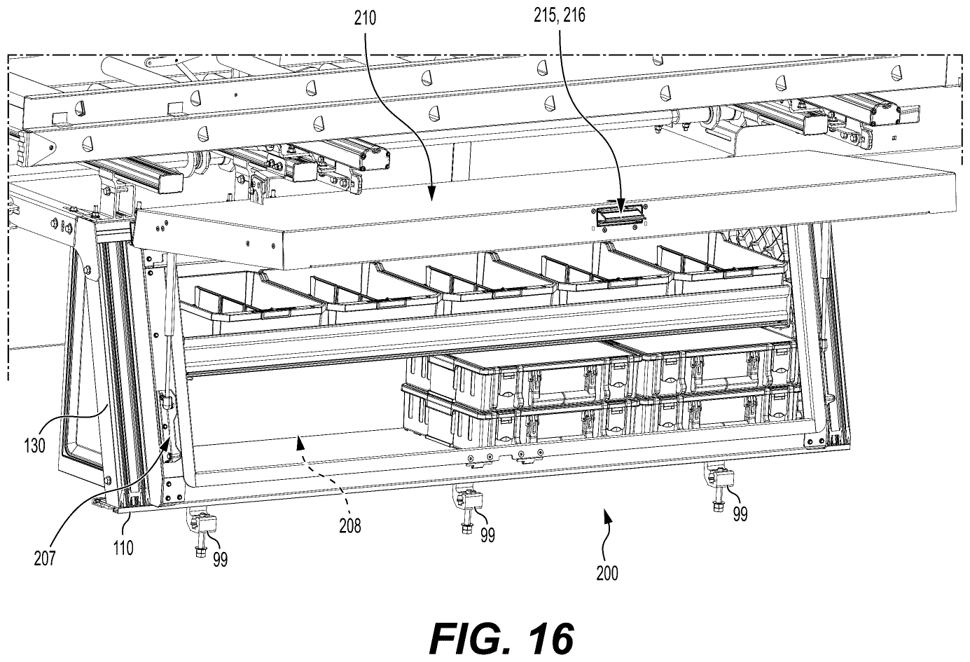

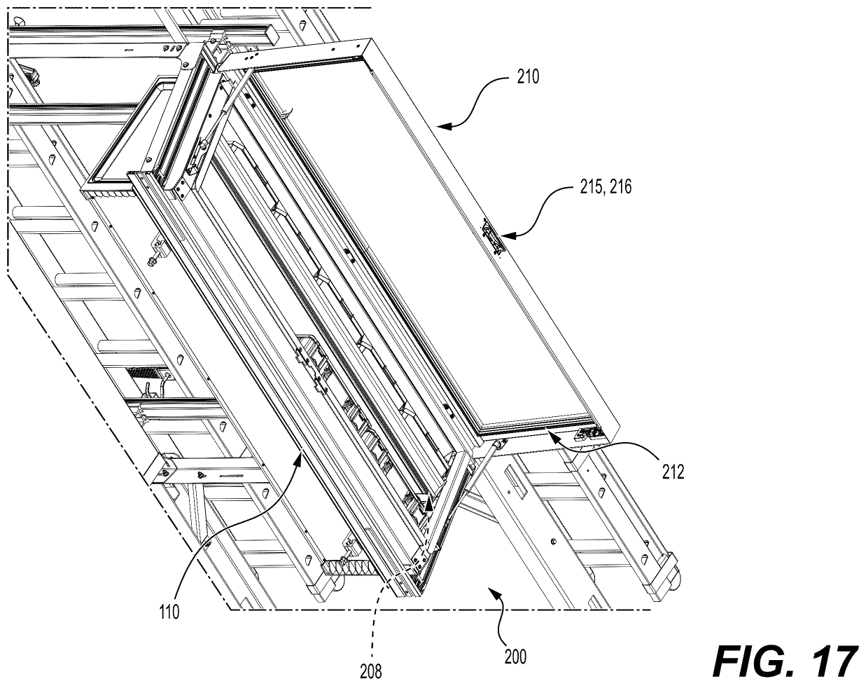

With additional reference to FIGS. 16 and 17, the toolboxes 200 will be described in more detail. As is illustrated in FIGS. 8 to 15, each toolbox 200 occupies an entirety of the lateral opening in the frame 101 formed between the forward and rearward disposed rising frame members 130.

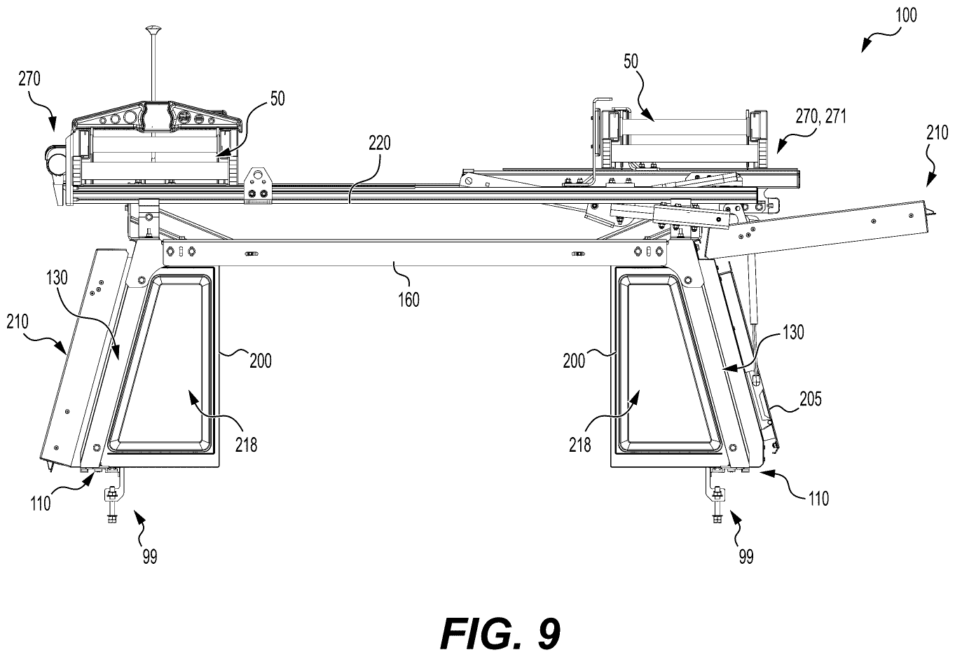

The toolbox 200 includes a toolbox body 205 defining a cavity 208 configured and shaped to receive objects therein. Interior walls of the body 205 extend generally vertically (inner most wall) and horizontally (top and bottom walls) when installed in the frame 101 (see for instance FIGS. 9 and 16). A top side of the toolbox body 205 is thus generally flat, permitting selective installation of both the toolbox 200 and the canopy 250, as mentioned above. In the illustrated embodiment, the body 205 has shelves and organizers disposed therein, but the particular interior arrangement is not meant to be especially limited. The toolbox 200 also includes a toolbox door 210 pivotally connected to the toolbox body 205, the toolbox door 210 selectively closing the cavity 208. When the toolbox 200 is installed in the frame 101, the toolbox door 210 extends generally parallel to the rising members 130 (when the door 210 is in a closed position).

When the toolbox 200 is connected to the frame 101, the toolbox body 20 closes the lateral side opening of the frame 101. The toolbox door 210 opens to an exterior of the frame 101. Users of the system 100 can thus access items stored in the cavity 208 from an exterior of the vehicle 10.

To aid in maintaining the integrity of items inside the toolbox body 205, the toolbox door 210 includes a sealing gasket 212 disposed on an interior side of the toolbox door 210. The sealing gasket 212 provides a sealing closure of the toolbox door 210, impeding the entry of rain or the elements into the toolbox body 205. To further aid in protecting items inside the toolbox 200 from the elements, the toolbox body 205 forms a gutter arrangement 207 therein. The gutters 207 provide a flow path for rain or fluids incident on the toolbox 200, away from the cavity 208.

By the present technology, the toolbox door 210 includes a latch 215 defined in a bottom side of the toolbox door 210 and hinges (not shown) connecting an upper edge of the toolbox door 210. A handle 216 of the toolbox door 210 for selectively opening the latch 215 is also disposed on the bottom side of the toolbox door 210. By positioning the latch 215 and the handle 216 on the bottom side of the toolbox door 210, a greater area on the lateral side of the door 210 is available for marking, aesthetic additions, advertising, and the like. The latch 215 and the handle 216 are also at least partially sheltered from the elements, which can aid in reducing freezing or blocking thereof. For at least some users, the handle 216 location is more ergonomic than a more traditional lower-door face positioning for a handle.

The toolbox 200 further includes a composite end cap 218 connected to a rear side of the toolbox body 205 (see FIG. 9). The composite end cap 218 is fastened or adhesively affixed to the toolbox body 205. The composite end cap 218 provides a surface for selectively fastening objects to the toolbox body 205. The end cap 218 may be drilled, nailed, and otherwise modified, without drilling or otherwise making holes in the toolbox body 205. In at least some embodiments, both ends of the toolbox 200 could have a composite end cap 218. In such embodiments, the toolbox 200 could be connected to the right or left side of the frame 101.

Modifications and improvements to the above-described embodiments of the present technology may become apparent to those skilled in the art. The foregoing description is intended to be exemplary rather than limiting. The scope of the present technology is therefore intended to be limited solely by the scope of the appended claims.

What is claimed is:

1. An accessory system for a vehicle having a pickup bed, the system comprising:
a frame configured for selectively connecting to a rear portion of the vehicle, the frame being connected to and extending over the pickup bed when the frame is installed on the vehicle,
the frame being arranged and configured to selectively receive a plurality of cooperating accessories, each accessory of the plurality of cooperating accessories being configured to connect to the frame individually and simultaneously with other accessories of the plurality of cooperating accessories.

2. The accessory system of claim 1, further comprising at least one accessory of the plurality of cooperating accessories.

3. The accessory system of claim 1, wherein the plurality of cooperating accessories comprises at least one of:
at least one toolbox;
at least one top rack member;
a cargo rack formed from a plurality of rack rigid members;
a cab rack extension;
a canopy;
a rear door;
a ladder rack;
at least one mounting hook;
at least one side door; and
a cab barrier.

4. The accessory system of claim 3, wherein:
the at least one toolbox comprises:
a toolbox body defining a cavity configured and shaped to receive objects therein, and
a toolbox door pivotally connected to the toolbox body, the toolbox door selectively closing the cavity; and
when the at least one toolbox is selectively connected to the frame:
the toolbox body closes a lateral side opening of the frame, and
the toolbox door opens to an exterior of the frame.

5. The accessory system of claim 1, wherein the frame comprises:
a first base frame member configured to selectively connect to a first side wall of the pickup bed;
a second base frame member configured to selectively connect to a second side wall of the pickup bed;
two first rising frame members connected to the first base frame member, a lower end portion of each first rising frame member being connected to the first base frame member;
two second rising frame members connected to the second base frame member, a lower end portion of each second rising frame member being connected to the first base frame member;
a first top frame member connected to upper end portions of the two first rising frame members;
a second top frame member connected to upper end portions of the two second rising frame members; and
a third top frame member extending between and connected to the first top frame member and the second top frame member.

6. The accessory system of claim 5, wherein the frame comprises a fourth top frame member extending between and connected to the first top frame member and the second top frame member, the fourth top frame member being disposed rearward of the third top frame member.

7. The accessory system of claim 5, wherein:
the first top frame member extends parallel to the first base frame member; and
the second top frame member extends parallel to the second base frame member.

8. The accessory system of claim 5, wherein:
each of the first rising frame members extends upward and inward from the first base frame member to the first top frame member; and
each of the second rising frame members extends upward and inward from the second base frame member to the second top frame member.

9. The accessory system of claim 5, wherein the third top frame member comprises:
a rigid member; and
at least one extension member moveably connected to the rigid member, the at least one extension member being selectively slidable relative to the rigid member permitting an adjustment of a width of the frame.

10. The accessory system of claim 5, wherein each of the first rising frame members and each of the second rising frame members has two slots defined therein, the two slots extending from the lower end portion to the upper end portion.

11. The accessory system of claim 10, wherein the two slots of each of the first rising frame members and each of the second rising frame members is shaped to selectively secure at least one fastener therein, each slot having an opening narrower than a largest width of the slot.

12. The accessory system of claim 5, wherein each of the first top frame member and the second top frame member comprises:
a top frame member body having four sides extending from a rear of the frame to a front portion of the frame,
the top frame member body having at least one slot defined in each of the four sides.

13. The accessory system of claim 12, wherein each of the four slots of the first top frame member and the second top frame member is shaped to selectively secure at least one fastener therein, each slot having an opening narrower than a maximum width of the slot.

14. The accessory system of claim 5, wherein the first base frame member, the second base frame member, the two first rising frame members, the two second rising frame members, the first top frame member, the second top frame member, and the third top frame member are formed from extruded aluminum.

15. The accessory system of claim 5, wherein each of the first base frame member and the second base frame member further comprises a plurality of clamps for selectively connecting the frame to side walls of the pickup bed.

16. A toolbox for an accessory system, the toolbox comprising:
a toolbox body defining a cavity configured and shaped to receive objects therein, the toolbox body being shaped and arranged to be received in an accessory system frame; and
a toolbox door pivotally connected to the toolbox body, the toolbox door selectively closing the cavity, the toolbox door including:
a latch defined in a bottom side of the toolbox door, and
a handle for selectively opening the latch, the handle being disposed on the bottom side of the toolbox door.

17. The toolbox of claim 16, wherein the toolbox door further comprises a sealing gasket disposed on an interior side of the toolbox door.

18. The toolbox of claim 16, further comprising at least one hinge pivotally connecting the toolbox door to the toolbox body via an upper edge of the toolbox door.

19. The toolbox of claim 16, wherein the toolbox body forms a gutter arrangement.

20. The toolbox of claim 16, further comprising at least one composite end cap for selectively fastening objects to the toolbox body.
